(19) United States
(12) Patent Application Publication
(10) Pub. No.: US 2015/0322805 A1
(43) Pub. Date: Nov. 12, 2015

(54) BLADE UNDERROOT SPACER WITH HOOK REMOVAL

(71) Applicant: UNITED TECHNOLOGIES CORPORATION, Hartford, CT (US)

(72) Inventor: James R. Murdock, Tolland, CT (US)

(73) Assignee: United Technologies Corporation, Hartford, CT (US)

(21) Appl. No.: 14/646,158

(22) PCT Filed: Feb. 18, 2013
(86) PCT No.: PCT/US13/26561

§ 371 Date: May 20, 2015

Related U.S. Application Data
(60) Provisional application No. 61/746,164, filed on Dec. 27, 2012.

(51) Int. Cl. F01D 5/30

(52) U.S. Cl. CPC F01D 5/3007; F05D 2220/32; F05D 2230/70

(57) ABSTRACT

A rotor for use in a gas turbine engine has rotor slots receiving a blade. The blades have an airfoil extending from a dovetail, and the dovetail is received by a rotor slot. A spacer is positioned between an inner wall of the dovetail and an outer wall of the slot, and the spacer is formed with a removal slot. A spacer, a gas turbine engine, and a method are also disclosed.

### CROSS-REFERENCE TO RELATED APPLICATIONS

This application claims priority to U.S. Provisional Application No. 61/746,164, filed Dec. 27, 2012

### STATEMENT REGARDING FEDERALLY SPONSORED RESEARCH OR DEVELOPMENT

This invention was made with government support under Contract No. NAS3-01138, awarded by NASA. The Government has certain rights in this invention.

### BACKGROUND OF THE INVENTION

This application relates to an underblade spacer which has a hook removal feature.

Gas turbine engines are known and, typically, include a fan delivering air into a compressor. Air from the compressor is passed into a combustion section where it is mixed with fuel and ignited. Products of this combustion pass downstream over turbine rotors driving them to rotate. The turbine rotors typically drive a fan rotor and a compressor rotor.

The fan compressor and turbine rotors may all be provided with blades which are removably mounted in slots in a rotor hub. In a fan, as an example, the fan blades often have a dovetail feature which is received within a slot or groove in a fan rotor. To bias the fan blade outwardly against surfaces of the hub, a resilient spacer is typically positioned radially inwardly of an underside of the fan blade. The resilient spacer may be inserted into the slot in the hub after the blade is mounted within the slot, as it may be pushed into a radial space between the underside of the blade dovetail and the slot. However, removing the spacer is challenging.

Typically, a threaded bore is formed in the spacer and a threaded removal member is turned into the threaded bore and then pulled.

The use of a threaded removal hole is expensive. Further, it requires a minimal total spacer thickness and eliminates many materials that might otherwise be useful for the spacer.

### SUMMARY OF THE INVENTION

In a featured embodiment, a rotor for use in a gas turbine engine has a plurality of rotor slots. Each of the rotor slots receive a blade. The blades have an airfoil extending radially outwardly of a dovetail, with the dovetail received within the rotor slot. A spacer is positioned radially between a radially inner wall of the dovetail and a radially outer wall of the slot. The spacer is formed with a removal slot.

In another embodiment according to the previous embodiment, the spacer is formed of a composite material.

In another embodiment according to any of the previous embodiments, the removal slot has an axially extending portion extending from an outer surface of the spacer to a circumferentially extending ear spaced inwardly from the outer surface.

In another embodiment according to any of the previous embodiments, the spacer extends axially for a first distance between axial end surfaces. The axially extending portion extends axially for a second distance away from an outer one of the axial end surfaces. A ratio of the first distance to the second distance is between 15 and 40.

In another embodiment according to any of the previous embodiments, the circumferentially extending ear extends circumferentially for a third distance from the axially extending portion and a ratio of the second distance to the third distance being between 0.4 and 0.8.

In another embodiment according to any of the previous embodiments, the rotor is a fan rotor.

In another embodiment according to any of the previous embodiments, there is a radially outer surface and a radially inner surface for the spacer. The slot extends from the radially outer surface partially into a body of the spacer, but does not reach the radially inner surface.

In another embodiment according to any of the previous embodiments, the spacer has a radially outer surface and a radially inner surface. The slot extends entirely through a body of the spacer from the radially outer surface to the radially inner surface.

In another featured embodiment, a spacer has a body ending axially for a first distance between axial end surfaces, and has curved circumferential sides. A removal slot includes an axially extending portion extending from one of the axial end surfaces and to a circumferentially extending ear spaced inwardly from the outer surface.

In another embodiment according to the previous embodiment, the body extends axially for a first distance between the axial end surfaces. The axially extending portion extends axially for a second distance away from one of the axial end surfaces. The circumferentially extending ear extends circumferentially for a third distance from the axially extending portion. A ratio of the first distance to the second distance is between 15 and 40. A ratio of the second distance to the third distance is between 0.4 and 0.8.

In another embodiment according to any of the previous embodiments, the spacer is formed of a composite material.

In another featured embodiment, a gas turbine engine has at least one of a fan, a compressor and a turbine. At least one of the fan, compressor and turbine include a rotor. The rotor has a plurality of rotor slots. Each of the rotor slots receives a blade. The blades have an airfoil extending radially outwardly of a dovetail. The dovetail is received within the rotor slot. A spacer is positioned radially between a radially inner wall of the dovetail and a radially outer wall of the slot. The spacer is formed with a removal slot.

In another embodiment according to the previous embodiment, the removal slot has a axially extending portion extending from an outer surface of the spacer to a circumferentially extending ear spaced inwardly from the outer surface.

In another embodiment according to any of the previous embodiments, the spacer extends axially for a first distance between axial end surfaces. The axially extending portion extends axially for a second distance away from an outer one of the axial end surfaces. A ratio of the first distance to the second distance is between 15 and 40.

In another embodiment according to any of the previous embodiments, the circumferentially extending ear extends circumferentially for a third distance from the axially extending portion. A ratio of the second distance to the third distance is between 0.4 and 0.8.

In another embodiment according to any of the previous embodiments, the rotor is in a fan.

In another embodiment according to any of the previous embodiments, the spacer is formed of a composite material.

In another embodiment according to any of the previous embodiments, there is a radially outer surface and a radially inner surface for the spacer. The slot extends from the radially outer surface partially into a body of the spacer, but does not reach the radially inner surface.

In another embodiment according to any of the previous embodiments, the spacer has a radially outer surface and a radially inner surface. The slot extends entirely through a body of the spacer from the radially outer surface to the radially inner surface.

In another featured embodiment, a method of removing a blade from a rotor for use in a gas turbine engine includes the steps of inserting a hook into a removal slot at an outer end of a spacer positioned radially inwardly of a dovetail of the blade to be removed. The spacer is pulled axially out of a rotor slot such that a blade may then be removed.

These and other features may be best understood from the following drawings and specification.

### BRIEF DESCRIPTION OF THE DRAWINGS

FIG. 1 shows a gas turbine engine.

FIG. 2 is a detail of a fan hub.

FIG. 3 shows a detail of the spacer.

FIG. 4 shows a method step in removal of the spacer.

FIG. 5 shows features of the spacer.

FIG. 6 shows an alternative spacer.

### DETAILED DESCRIPTION

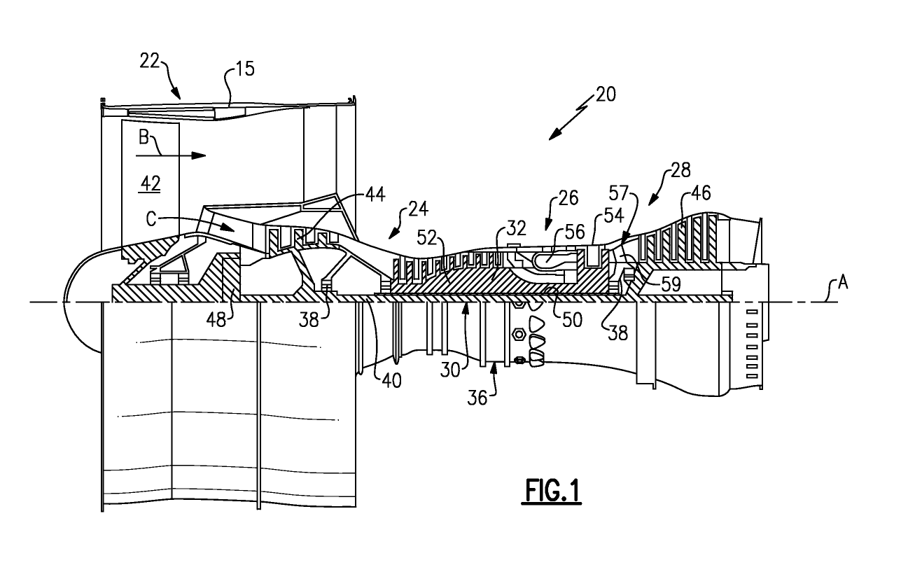

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines including three-spool architectures.

The engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that interconnects a fan 42, a low pressure compressor 44 and a low pressure turbine 46. The inner shaft 40 is connected to the fan 42 through a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path. The turbines 46, 54 rotationally drive the respective low speed spool 30 and high speed spool 32 in response to the expansion.

The engine 20 in one example is a high-bypass geared aircraft engine. In a further example, the engine 20 bypass ratio is greater than about six (6), with an example embodiment being greater than ten (10), the geared architecture 48 is an epicyclic gear train, such as a planetary gear system or other gear system, with a gear reduction ratio of greater than about 2.3 and the low pressure turbine 46 has a pressure ratio that is greater than about 5. In one disclosed embodiment, the engine 20 bypass ratio is greater than about ten (10:1), the fan diameter is significantly larger than that of the low pressure compressor 44, and the low pressure turbine 46 has a pressure ratio that is greater than about 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.5:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFCT’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second.

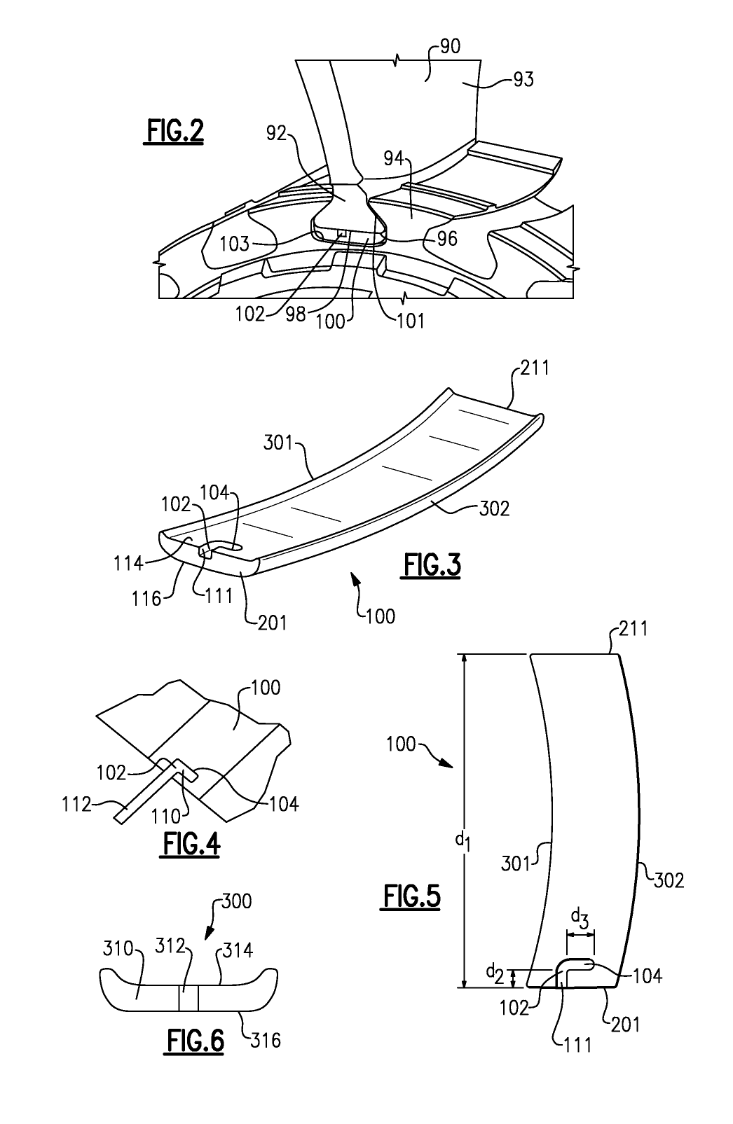

FIG. 2 shows a fan blade 90 mounted with a dovetail 92 in a hub 94. As known, an airfoil 93 extends radially outwardly of the dovetail 92 relative to the engine core axis A (see FIG. 1). The dovetail 92 is received within a slot 96 within the hub 94. The slot has a lower surface 103, which faces in a radially outer direction, and sidewalls 101, which are contoured to form an acute angle with the lower surface 103, thereby substantially facing a radially inner direction. A spacer 100 biases the dovetail 92 radially outwardly such that sides of the dovetail are urged against sides 101 of the slot 96. This holds the fan blade 90 securely within the slot 96, even when the rotor 94 is being driven to rotate.

Insertion of the spacer 100 is relatively simple as it may be forced into a space between the blade 90 and the slot 96. Removal of the spacer 100, however, can be a relatively difficult task.

As shown in FIG. 3, a slot 102 is formed with a circumferentially extending ear 104. Due to the slot, the spacer 100 may be formed of any number of materials and may be thinner than the prior art threaded spacer. As an example, composite materials can be used, which would otherwise not be feasible, since forming a threaded hole in a composite material would be difficult. As is clear, the slot 102 does not extend entirely from a radially outer surface 114 to a radially inner surface 116 in this embodiment.

The slot 102 has an axially extending portion 111, extending from an outer end surface 201 of the spacer 100 to the circumferentially extending ear 104, which is spaced inwardly from the outer end surface 201. While an L-shaped slot 102 is disclosed, any number of other shapes may be utilized.

As shown in FIG. 4, a hook 112 is inserted into the slot 102 and the hook 112 has an ear 110 that fits into the circumferentially extending ear 104. The spacer 100 may then be pulled outwardly of the slot 96. Once spacer 100 is removed the blade 90 can then be easily removed.

As can be appreciated in FIGS. 3 and 5, spacer 100 has curved circumferential sides 301 and 302, and generally parallel surfaces at outer end surface 201 and inner end surface 211. The term “outer” and “inner” refer to a direction further into an associated gas turbine engine.

As shown in FIG. 5, a distance d₁ can be defined between outer and inner end surfaces 201 and 211. A second distance d₂ can be defined along the axially extending portion 111, to the location where the circumferentially extending ear 104 begins. The ear 104 extends for a third distance d₃ from the beginning of the axially extending portion 111. In embodiments, d₁ was 7.72 in inch (19.6 cm), d₂ was 0.393 inch (0.998 cm) and d₃ was 0.627 inch (1.59 cm).

In embodiments, a ratio of d₂ to d₃ was between 0.4 and 0.8. A ratio of d₁ to d₂ was between 15 and 40.

FIG. 6 shows another embodiment spacer 300, wherein the slot 312 extends entirely from the radially outer surface 314 to the radially inner surface 316, and into an axially outer end surface 310.

The spacers of this application may be injection molded from an appropriate composite material, such as an engineered plastic. One appropriate engineered plastic is available from DuPont Corporation under the trade name Zytel™.

Of course, other materials may be utilized.

While the spacer is shown as part of a fan blade, it may have applications in other gas turbine engine rotors, such as a compressor or turbine section.

Although an embodiment of this invention has been disclosed, a worker of ordinary skill in this art would recognize that certain modifications would come within the scope of this invention. For that reason, the following claims should be studied to determine the true scope and content of this invention.

1. A rotor for use in a gas turbine engine comprising:
a plurality of rotor slots, each of said rotor slots receiving a blade, said blades having an airfoil extending radially outwardly of a dovetail, with the dovetail received within the rotor slot; and
a spacer positioned radially between a radially inner wall of said dovetail and a radially outer wall of said slot, with said spacer being formed with a removal slot.

2. The rotor as set forth in claim 1, wherein said spacer is formed of a composite material.

3. The rotor as set forth in claim 1, wherein said removal slot has an axially extending portion extending from an outer surface of said spacer to a circumferentially extending ear spaced inwardly from said outer surface.

4. The rotor as set forth in claim 3, wherein said spacer extends axially for a first distance between axial end surfaces, said axially extending portion extends axially for a second distance away from an outer one of said axial end surfaces, and a ratio of said first distance to said second distance being between 15 and 40.

5. The rotor as set forth in claim 4, wherein said circumferentially extending ear extends circumferentially for a third distance from said axially extending portion and a ratio of said second distance to said third distance being between 0.4 and 0.8.

6. The rotor as set forth in claim 1, wherein said rotor is a fan rotor.

7. The rotor as set forth in claim 1, wherein there being a radially outer surface and a radially inner surface for said spacer, and said slot extending from said radially outer surface partially into a body of said spacer, and not reaching said radially inner surface.

8. The rotor as set forth in claim 1, wherein said spacer having a radially outer surface and a radially inner surface, and said slot extending entirely through a body of said spacer from said radially outer surface to said radially inner surface.

9. A spacer comprising:
a body ending axially for a first distance between axial end surfaces, and having curved circumferential sides, a removal slot including an axially extending portion extending from one of said axial end surfaces and to a circumferentially extending ear spaced inwardly from said outer surface.

10. The spacer as set forth in claim 9, wherein said body extends axially for a first distance between said axial end surfaces, said axially extending portion extends axially for a second distance away from said one of said axial end surfaces, and said circumferentially extending ear extends circumferentially for a third distance from said axially extending portion, and a ratio of said first distance to said second distance being between 15 and 40, and a ratio of said second distance to said third distance being between 0.4 and 0.8.

11. The spacer as set forth in claim 9, wherein said spacer is formed of a composite material.

12. A gas turbine engine comprising:
at least one of a fan, a compressor and a turbine wherein said at least one of said fan, compressor and said turbine including a rotor, and with the rotor having a plurality of rotor slots, each of said rotor slots receiving a blade, said blades having an airfoil extending radially outwardly of a dovetail, with the dovetail received within the rotor slot; and
a spacer positioned radially between a radially inner wall of said dovetail and a radially outer wall of said slot, with said spacer being formed with a removal slot.

13. The gas turbine engine as set forth in claim 12, wherein said removal slot has a axially extending portion extending from an outer surface of said spacer to a circumferentially extending ear spaced inwardly from said outer surface.

14. The gas turbine as set forth in claim 13, wherein said spacer extends axially for a first distance between axial end surfaces, said axially extending portion extends axially for a second distance away from an outer one of said axial end surfaces, and a ratio of said first distance to said second distance being between 15 and 40.

15. The gas turbine engine as set forth in claim 14, wherein said circumferentially extending ear extends circumferentially for a third distance from said axially extending portion and a ratio of said second distance to said third distance being between 0.4 and 0.8.

16. The gas turbine engine as set forth in claim 12, wherein said rotor is in a fan.

17. The gas turbine engine as set forth in claim 12, wherein said spacer is formed of a composite material.

18. The gas turbine engine as set forth in claim 12, wherein there being a radially outer surface and a radially inner surface for said spacer, and said slot extending from said radially outer surface partially into a body of said spacer, and not reaching said radially inner surface.

19. The gas turbine engine as set forth in claim 12, wherein said spacer having a radially outer surface and a radially inner surface, and said slot extending entirely through a body of said spacer from said radially outer surface to said radially inner surface.

20. A method of removing a blade from a rotor for use in a gas turbine engine comprising steps of:
inserting a hook into a removal slot at an outer end of a spacer positioned radially inwardly of a dovetail of the blade to be removed, and pulling the spacer axially out of a rotor slot such that a blade may then be removed.
